(19) United States
(12) Patent Application Publication
(10) Pub. No.: US 2020/0027326 A1
(43) Pub. Date: Jan. 23, 2020

(54) SECURITY DRONE WITH NON-LETHAL DETERRENT

(71) Applicant: Amcrest Global Holdings Limited, Dublin (IE)

(72) Inventor: Abdurahman RAVAT, Houston, TX (US)

(21) Appl. No.: 16/042,635

(22) Filed: Jul. 23, 2018

(51) Int. Cl. G08B 15/02; G08B 15/00; G08B 13/26; G08B 13/196; B64C 39/02; G05D 1/00

(52) U.S. Cl. CPC G08B 15/02; G08B 15/005; G08B 13/26; G08B 13/196; B64C 2201/141; G05D 1/0094; G05D 1/0088; B64C 2201/12; B64C 39/024

(57) ABSTRACT

A drone for deterring intruders within a monitored area includes a multirotor aerial vehicle with an electric drive apparatus and a power supply configured to provide electrical energy. A controller is configured to control the multirotor aerial vehicle. A first sensor is in electrical communication with the controller, the sensor configured to provide navigation information to the controller. A wireless communication circuit is in electrical communication with the controller, and in wireless communication with an external wireless transceiver. A deterrence effector bay is in electrical communication with the controller. The deterrence effector bay includes a non-lethal deterrence effector and an actuator. Activation of the actuator causes the delivery of the non-lethal deterrence effector to a target. The drone may be used in conjunction with an alarm system as a deterrent against intrusion.

### BACKGROUND OF THE INVENTION

### 1. Field of the Invention

The present invention relates to a drone for use with security systems.

### 2. Description of the Prior Art

Unmanned aerial vehicles (UAV) or drones as they are more commonly known today, are well known as automated vehicles that may be remotely controlled. Drones are used by hobby enthusiasts, commercial interests and military forces around the world. Drones are commonly outfitted with a camera, so a user at a remote location may see where the drone is going. Drones are available from mail order and online catalogues, and at electronics and hobby stores. They may have high resolution cameras and come in a variety of form factors.

The MQ-1B Predator is an example of a military drone with a strike capability. The drone can be remotely operated and has a long endurance for performing military missions. The drone is expensive and is not designed for civilian use. The RQ-11B Raven is a “cheap” military drone with only a camera for scouting purposes. This drone is used by military forces and costs about $173,000 in 2004 dollars. It is manually launched (thrown by a soldier into the air) and can stay airborne for about 90 minutes.

On the commercial side, a variety of drone technologies exist for parcel delivery, site monitoring and security usage. In U.S. Pat. No. 9,523,986, there is described a system for using drones to deliver packages. In this commercial system, drones are controlled by a program that coordinates package delivery by optimizing the movement of drones carrying packages in a given volume of space. The program can coordinate multiple drones simultaneously.

In U.S. Pat. No. 9,162,753 there is described a drone used for monitoring utility sites. The drone is controlled by a remote user and flies to a series of pre-established way points. The drone is used to monitor things like utility lines, pipes or other structures that can be viewed from the air. The technology allows for multiple drones to be used in a serial fashion, so when one drone is returning to refuel, another drone can move to the next site.

Drones are also used for site security. In U.S. Pat. No. 9,633,547 there is described a drone that can be activated by a security system once a potential intruder is detected. The drone may move toward the sensor that detected the potential intruder, and monitor the intruder by taking pictures, and by scanning for an unpaired wireless device on the potential intruder (i.e. a cell phone). By capturing the device detail, the system can record data to later be used to identify the potential intruder by the unpaired wireless data.

In U.S. Pat. No. 9,819,911 there is a system of using drones with cameras to perform security sweeps of a facility (indoor or outdoor) at regular intervals, or in response to a detected potential threat.

In the various references, there are a wide variety of options for drones with cameras to investigate and record images. In military applications, there are drones which can perform surveillance and conduct strike operations with lethal munitions (which are obviously unsuited for urban environments). Unfortunately, drones with cameras do not replace a good human guard. A guard has the ability to observe a potential intruder, evaluate the threat or risk to property and self, and determine if the guard should respond directly to the intruder, flee or call for assistance. Thus, there is a need for a drone that can survey a potential threat, evaluate it and if needed, provide a direct, on the spot non-lethal deterrent to intrusion. There is further a need for a drone that can compel an intruder to leave the premise being secured. There is still further a need for a drone that can accomplish the deterrent goal without causing property damage or permanent physical harm to the intruder. At least one of these needs is met with the security drone using a non-lethal deterrence effector.

### SUMMARY OF THE INVENTION

As used herein, the terms “drone” and “unmanned aerial vehicle (UAV)” mean the same thing and are used interchangeably in this disclosure.

In an embodiment, an unmanned aerial vehicle (UAV) or drone may be used for deterring intruders within a monitored area. The drone is a multirotor aerial vehicle with an electric drive and a power supply configured to provide electrical energy. The drone has a controller configured to control the multirotor aerial vehicle, a first sensor in electrical communication with the controller, the sensor configured to provide navigation information to the controller, a wireless communication circuit in electrical communication with the controller, and in wireless communication with an external wireless transceiver and a deterrence effector bay in electrical communication with the controller. The deterrence effector bay contains a non-lethal deterrence effector and an actuator. Activation of the actuator causes the delivery of the non-lethal deterrence effector at a target.

In an embodiment, the drone's controller may be further configured to control deterrence effector delivery: to detect the target, and upon detecting the target, to direct the flight of the multirotor aerial vehicle to align the direction of delivery of the deterrence effector to the direction of the target, and to actuate the actuator to deliver the deterrence effector at the target.

In an embodiment, the controller is a processor. In another embodiment, the processor may have an integrated or adjunct non-volatile memory device, the memory device storing a software library. The software library may store one or more of a deterrence effector controller software, a sensor controller software, a flight controller software and a software for control of deterrence effector delivery.

In some embodiments, the first sensor may be one of: an optical camera, a GPS sensor, a proximity sensor, an echo location sensor, an RF sensor, and/or a waypoint sensor.

In some embodiments, the drone may control the operation of the first sensor by sensor controller software comprising correction logic, and additionally, the first sensor controller software may be configured with navigation logic. The navigation logic may override the instructions of the controller in piloting the drone. In some embodiments, the first sensor may be a targeting sensor. In some embodiments, the drone has two or more sensors, and any of the sensors may be a targeting sensor. Likewise the controller may navigate the drone using any combination of sensor data from the one or more sensors. The sensors may be any one of: an optical camera, a GPS sensor, a proximity sensor, an echo location sensor, an RF sensor, and a waypoint sensor. In some aspects, any one or more of the sensors may be used as a targeting sensor.

In some embodiments, the deterrence effector bay may be removable or replaceable. In some embodiments, the deterrence effector bay may be internal to the drone, or external to the drone. In various embodiments the effector bay has an actuator, which may be one of; a valve, a spray nozzle, a vent, a hammer and a trigger mechanism, a spring, a pneumatic driver, an electric motor, a magnetic or a thermal driver. The deterrence effector bay further may have a second sensor in signal communication with the controller.

In various embodiments, the non-lethal deterrence effector may be any one or more of a sound generator, a light generator, a chemical spray, a liquid discharge, an electrical discharge and a projectile device.

In an embodiment, there is described a security system for detecting and deterring intruders with a non-lethal deterrence effector. The security system has a control hub, a first sensor in signal communication with the control hub and a first unmanned aerial vehicle (UAV) in signal communication with the control hub. The drone may be configured to deliver a non-lethal deterrence effector. The first sensor of the system may detect a target entering the first sensor's range, then signal the control hub to deploy the drone to investigate the target.

In some embodiments, the control hub of the security system may be a security agent acting on behalf of an external security service provider. The security agent may be autonomous in coordinating sensor data from the first sensor and the deployment of the drone to investigate the target. Either the control hub or the drone (or both) has a delivery option enumerator software for computing a set of delivery options in accordance with a set of constraint parameters to select one or more of available non-lethal deterrence effectors to deliver to the target.

In other embodiments, the system may include a second UAV without a non-lethal deterrence effector. The control hub may deploy the second UAV to investigate the target identified by the sensor, the second UAV including a discretion option enumerator software for computing whether the target identified by the sensor requires the use of a non-lethal deterrence effector.

In an embodiment, there is a method of controlling a UAV for delivery of a deterrence effector at a target. The method involves activating the drone via a wireless communication protocol, selecting a preprogrammed flight profile from a software library, running the preprogrammed flight profile through a controller on board the drone, detecting a target, directing a controller to correct the drone orientation so as to align a direction of discharge of the non-lethal deterrence effector at the target, delivering the non-lethal deterrence effector at the target and returning the drone to a recharging base.

In some embodiments, the method may also involve, receiving a target position alert from a security system, deploying an observation drone to the position of an intruder, verifying the intruder and signaling for the activation of a drone for delivery of a non-lethal deterrence effector at the target.

### BRIEF DESCRIPTION OF THE DRAWINGS

FIG. 1 illustrates a drone configured to use a deterrence effector according to an embodiment.

FIG. 2 illustrates an embodiment of a cartridge according to an embodiment.

FIG. 3 illustrates a schematic of the cartridge according to an embodiment.

FIG. 4 illustrates a movable mount for a deterrence effector according to an embodiment

FIG. 5 illustrates a security drone operating over a property according to an embodiment.

FIG. 6 illustrates a landing pad for a drone with a deterrence effector according to an embodiment.

FIG. 7 illustrates a flow chart of a security system process according to an embodiment.

FIG. 8 illustrates an aiming sensor separate from a drone guidance sensor according to an embodiment.

### DETAILED DESCRIPTION OF THE INVENTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

An unmanned aerial vehicle (UAV), commonly referred to as a drone, is an aircraft without a human pilot on board. As used herein, the terms “drone” and “unmanned aerial vehicle (UAV)” mean the same thing and are used interchangeably in this disclosure.

Reference to the drawings and various embodiments herein may use notations. In describing the features of the embodiments, a drawing part may be identified by a number and a subscript. The subscript indicates there are multiple numbers of the same feature or part. The subscript may have a specific number, or a generic value, such as x or n. In either case, the use of an x or n indicates there is no limit to the number of features or parts of the particular reference number. The embodiment may utilize as many of those parts as may be needed or desired. The exact number may often depend on the embodiment desired. It may be apparent to those skilled in the art that alternative embodiments may use many or few of the same part. For example, an aerial drone may use one propeller or more. Some drones use four propellers and are commonly referred to as “quadcopters.” Other drones may use six propellers. Still others may use counter rotating propellers on a single axis, with multiple axis of motor power. In such embodiments describing the number of propellers a drone may have becomes difficult since the number is limited only by imagination and mechanical design. Thus a part like the propeller may be referred to by a sample part number 10 and the subscript 1-n, simply meaning there may be 1 or more of these parts, and the number depends on the embodiment. For notation purposes, this reference will appear in the description as 10₁₋ₙ.

Some embodiments may use words like “generally” or “substantially” to describe embodiments or aspects of embodiments. As used herein, these terms refer to a specific value+/−15% of the value. If the value is provided as a range, then the use of these terms means within 15% of the value given. For example, when discussing the dimension of a part, it might be the part may be from 10-15 inches in length. If the part is substantially 10-15 inches in length, we mean the part may be 10-15 inches, +/−15 percent.

Elements of the drawings are representative components of the material, ideas and technical information described herein. The drawings are not to be taken as literal in relative dimensions of various components to itself or other components in the same diagram or figure. Nor are any shapes of components to be prescribed to their corresponding written description as all elements are merely illustrative.

Described herein are various embodiments of a deterrence drone for use with a security system. The deterrence drone may be a drone similar to a multirotor, quadcopter or fixed wing aircraft drone in some embodiments. The drone may have similar features to existing drones as far as motive capability, flight control electronics, power supply and any other components used to make a drone move. The deterrence drone may have additional features, such as the use of a deterrence component, a tracking capability to follow a mobile intruder, and a trigger feature to deliver the deterrence component on command. The command may be a user initiated instruction, or an automated deployment program based on a predetermined set of parameters. In some embodiments the deterrence drone may be used with a security system. The security system may deploy one or more sensors to detect the presence of an intruder. The security system may also deploy a first drone to inspect an alarm event, and a second deterrence drone to carry out a deterrence operation against a positively identified intruder. The initial drone may serve as a scout, and may be a small and inexpensive drone that mimics the capabilities of an off the shelf drone. It may be lighter than the drone with the non-lethal deterrence effector (NLDE), so it may be deployed without using as much energy. Use of a scout drone may preserve the charge on the drone with the NLDE until it is needed. The drone with the NLDE may be larger and heavier than a scout drone. It may also be more expensive.

Alternatively, in some embodiments, the security system may use just the deterrence drone to both investigate, verify and deter an intruder. For purposes of this disclosure, an intruder may be any unwelcomed or unwanted trespasser into a defined property space, such as a human, an animal or another drone.

The security system may be any system currently available that includes at least one sensor for detecting the presence of a potential intruder within a defined boundary. The boundary may be the meets and bounds of a parcel of land, a fenced area such as a warehouse perimeter, business lot or any other area the system may be tied to. In some embodiments, the area or volume of space protected by the drone with the NLDE may be an indoor volume, and outdoor volume or a combination of indoor and outdoor. The security system may have a wired or wireless connection between the sensor and a primary control module. The control module may provide signal coordination between the sensors and a potential alert mode (such as notifying a security monitoring service, police, fire or other emergency services, or the owner/manager of the property being secured). The details of general alarm systems are known in the prior art and this disclosure focuses on the elements of the security system that are enhanced with the present disclosure.

The enhancements to any current security system may include the use of a deterrence drone, and potentially a scout drone. When the security system detects an intruder, a scout drone may be deployed to the location of the alarm trigger. The scout drone may be docked to a drone landing pad located within the area covered by the security system, nearby that area or at a remote location. If the alarm is caused by a motion sensor outside a building, the scout drone may be deployed to the area of the alarm. If an intruder is detected, a second drone with an NLDE may be deployed to perform a deterrence operation. The NLDE drone may be docked to a drone landing pad also located within the area covered by the security system, nearby that area or at a remote location. The scout drone and NLDE drone may be at the same or at different locations. The deterrence operation may depend on the deterrence module the drone is carrying, and the type of intruder that is discovered on the property.

In some embodiments, the cost of a single drone to perform multiple functions may be cost prohibitive. In other aspects, it may be the use of a single drone may be more efficient for logistics purposes and for stowage and maintenance purposes. Ultimately it may be a user's preference to decide whether to use two drone, one drone, or a combination of one or more scout drones and one or more deterrence drones. Described herein are various embodiments of a drone or UAV with a non-lethal deterrence effector. As a short hand, UAV-NL is used to designate a drone with one or more non-lethal deterrence effectors. The UAV-NL is distinguished from a “scout” or “reconnaissance” drone, which refers to a drone or UAV that does not carry a NLDE. The scout/reconnaissance term is used interchangeably herein, and is meant to refer to a UAV that may be an off the shelf drone, not inherently having any innovation related to the present disclosure. Alternatively, the scout drone may be custom designed for a particular application of the user. Some methods described herein call for the use of a first drone and/or a second drone. The type of drone can be distinguished using the UAV-NL nomenclature to distinguish the kind of drone envisioned for that particular description. The context of use may be relied on as well to determine if a term like “UAV” or “drone” refers to a UAV with or without a non-lethal deterrence effector.

A wide variety of non-lethal deterrence effectors are envisioned for use with the drone, either individually or in combination with other NLDE. In some embodiments, the drone may be equipped with a sound generator or strobe light. In some embodiments the drone may be equipped with a chemical reagent, such as pepper spray. In still other embodiments, the drone may be equipped with a projectile of some kind. These projectiles may include electrical leads for a taser like weapon, paint ball pellets, or other ammunition that may be used to frighten, annoy or scare an intruder away. The deterrence drone may not be equipped with guns or weapons with a high likelihood to mortally wound an intruder (animal or human). In addition to the deterrence, the drone may be equipped with extended battery or fuel capabilities. This extended battery allows the deterrence drone to carry a heavier load than a drone only carrying a camera, and also allows the drone to pursue an intruder to the edge of a property to ensure the intruder has left the premises. The deterrence drone may include additional sensor that may be used for collision avoidance, multi direction image capture, navigation, night vision, infrared sensing, way point navigation, automated flight modes (such as loiter, landing, taking off, pursuing intruders, or other tasks). The drone may be equipped with a program to monitor the battery charge or fuel supply, and make use of an automatic return to base type feature if the battery or fuel reaches a critically low level. In some embodiments, a second deterrence drone may take over for a drone returning to base for either recharge or resupply (or to replace a deterrence drone that becomes disabled). The drone may use a battery recharge system capable of wireless recharging to facilitate the ease of recharging between flights. In some embodiments the battery may have a quick connect for a direct wire recharge system. In some embodiments the drone may use more than one method for recharging batteries. In some embodiments there may be a device on the landing pad to reload the deterrence effector onto the drone. In some aspects, the reloading device may be part of the drone itself.

The present disclosure relates to a drone for deterring intruders within a monitored area. The apparatus comprises a multirotor aerial vehicle with an electric drive apparatus and a power supply configured to provide electrical energy, a controller configured to control the multirotor aerial vehicle, a first sensor in electrical communication with the controller, the sensor configured to provide navigation information to the controller, a wireless communication circuit in electrical communication with the controller, and in wireless communication with an external wireless transceiver and a deterrence effector bay in electrical communication with the controller, the deterrence effector bay comprising a non-lethal deterrence effector and an actuator, wherein activation of the actuator causes the delivery of the non-lethal deterrence effector to a target. The present UAV-NL may be used in conjunction with an alarm system as a deterrent against intrusion.

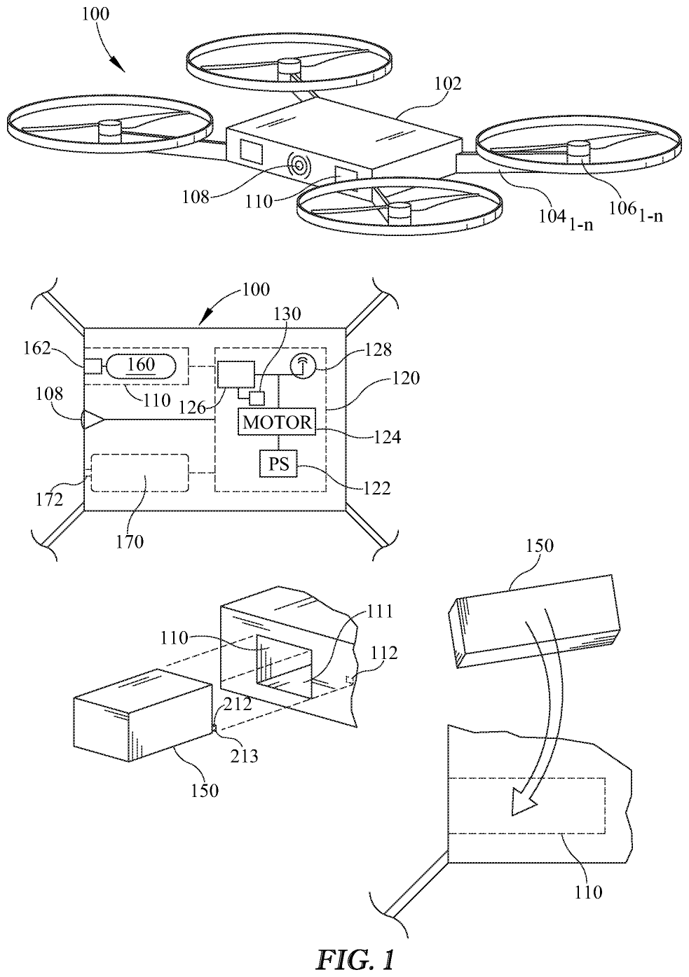

FIG. 1 illustrates an unmanned aerial vehicle (UAV-NL) or drone 100 configured to use a deterrence effector according this disclosure. The drone 100 may be used for deterring intruders within a monitored area. The drone 100 includes a multirotor aerial vehicle 102 comprising an electric drive apparatus 124 and a power supply 122 configured to provide electrical energy. The drone may have a controller 126 configured to control the multirotor aerial vehicle 102. A first sensor 108 may be in electrical communication with the controller 126, such that the first sensor 108 may provide navigation information to the controller 126. A wireless communication circuit 128 may be in electrical communication with the controller 126, and in wireless communication with an external wireless transceiver. A deterrence effector bay 110 may also be in electrical communication with the controller 126, the deterrence effector bay 110 may contain one or more non-lethal deterrence effector(s) 160 and one or more actuator(s) 162. The activation of the actuator may cause the delivery of the non-lethal deterrence effector 160 to a target. The electric drive apparatus 124, power supply 122, controller 126, wireless communication circuit 128 and other electrical elements or components needed for flying the multirotor aerial vehicle form the UAV-NL avionics 120.

Generally, the multirotor aerial multirotor aerial vehicle 102 is provided with one or more arms 104₁₋ₙ for connecting the main body of the multirotor aerial vehicle to the various rotors 106₁₋ₙ. Rotors 106₁₋ₙ including their associated rotor blades, referred to as propellers 107₁₋ₙ, provide the lift for flying the drone. The configuration of the arms and lift producing rotors depends of the design of the multirotor aerial vehicle, and the exact configuration of these components is disclosure matter of design choice.

In some embodiments, the controller may execute software configured for control of the delivery of the deterrence effector. This software may involve instructions for detection of the target, and upon detecting the target, to direct the flight of the multirotor aerial vehicle to align the direction of delivery of the deterrence effector to the direction of the target, and to actuate the actuator to deliver the deterrence effector at the target.

In some embodiments, the controller may be a processor. In some embodiments, the processor may have an integrated or adjunct non-volatile memory device. The memory device may store a software library 130. The software library 130 may contain one or more of a deterrence effector controller software, a sensor controller software, a controller software and a software for control of deterrence effector delivery. Alternatively, the software library 130 may be stored in a server in the cloud and executed on the server. Control instructions from the software instructions executed in the cloud may be communicated to the controller 126 for execution on the drone.

In various embodiments, the multirotor aerial vehicle 102 has a sensor 108. In some embodiment the multirotor aerial vehicle may have more than one sensor 108₁₋ₙ. The sensor 108 may be any device configured to provide data related to the multirotor aerial vehicle's environment to the controller 126. Some examples of possible sensors 108₁₋ₙ usable with the multirotor aerial vehicle include, but are not limited too; an optical camera, a GPS sensor, a proximity sensor, an echo location sensor, an RF sensor, and a waypoint sensor. In some embodiments, the sensor may be any one of a variety of optical cameras, such as may be used on other flying drones. In some embodiments, the optical camera may use digital imaging to “see”. Image data may be recorded and preserved either in on-board memory, or transferred to an external memory device using the wireless communication circuit. Sensor data from any or all of the sensors on the multirotor aerial vehicle may similarly be recorded and stored.

In some embodiments, the control of the operation of the first sensor may be provided by sensor controller software comprising correction logic, and the first sensor controller software may be further configured with navigation logic. In an aspect, the first sensor may be the principle sensor used for navigation of the multirotor aerial vehicle. The sensor controller software may have a correction logic to properly display or otherwise calculate flight path based on the data provided. Correction logic may also be used for error detection and correction. The navigation logic can provide flight direction and parameters for safe flight. In some embodiments the correction logic or navigation logic may provide collision avoidance, duration calculation (time remaining before fuel or battery is exhausted), station keeping, coordinated flight with other drones in signal connection with the UAV-NL or with the control hub.

In some embodiments, the navigation logic may override the instructions of the controller in piloting the drone.

In some embodiments, the first sensor 108 or any one or more of the additional sensors 108₁₋ₙ, may also be a targeting sensor.

In some embodiments the controller 126 may navigate the multirotor aerial vehicle 102 using a combination of sensor data from the plurality of sensors 108₁₋ₙ.

Referring still to FIG. 1, in the various embodiments, the UAV-NL 100 may contain the deterrence effector bay 110 for the storage or placement of at least one non-lethal deterrence effector. The deterrence effector bay 110 may be a distinct portion of the multirotor aerial vehicle 102, or it may be a space within the multirotor aerial vehicle that may be dedicated to the use of the non-lethal deterrence effector. The bay may contain an actuator 162 for delivering the non-lethal deterrence effector. In some embodiments, the non-lethal deterrence effector, that is to say, the NLDE, may be depleted with use as further described herein. In some embodiments the non-lethal deterrence effector may use a chemical, electrical, pneumatic or other force to deliver the non-lethal deterrence effector to a target. In some embodiments, the agent that delivers the NLDE may be depleted during use. In some embodiments, both the NLDE itself, and the agent used to deliver the NLDE to a target may both be depleted. In the various embodiments, a storage tank 160 may be used to house the depletable NLDE, or the depletable agent, or both. The actuator 162 may be a switch, a nozzle, a valve, a vent, a hammer and a trigger mechanism, a spring, a pneumatic driver, an electric motor, a magnetic driver or a thermal driver. The actuator may be any additional mechanical or electrical device that may cause the delivery of the NLDE on command. In some embodiments the actuator may be a combination of any of the above, such as using a switch to activate a driver. In some embodiments, the NLDE bay may include a separate sensor in signal communication with the controller.

In some embodiments the deterrence effector bay may be a compartment 170 for receiving a removable pod or cartridge 150. Access to the deterrence effector bay for placement of the cartridge 150 may be in the front, side, top or bottom of the UAV-NL. The compartment 170 may have an opening or aperture 172, allowing the NLDE to exit the multirotor aerial vehicle.

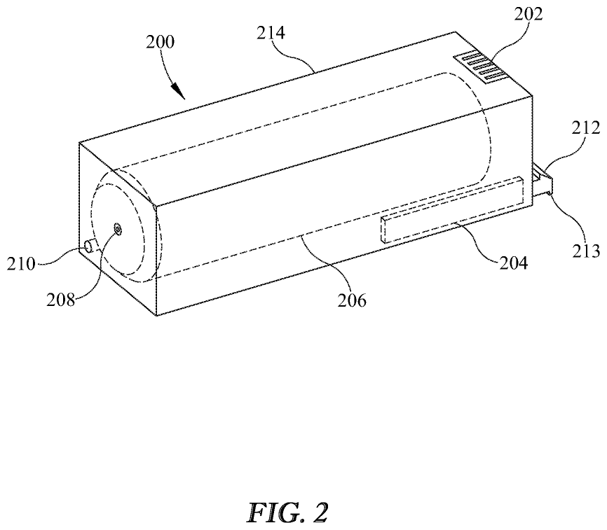

FIG. 2 depicts a removable cartridge 200, which is the removable cartridge 150 shown in FIG. 1 shown in greater detail. The cartridge 200 may be optimized for easy insertion and removal from a multirotor aerial vehicle. The cartridge 200 may be any form factor or shape well suited for use in, on or with the multirotor aerial vehicle. The cartridge 200 may have a housing 214 as shown in FIG. 2. The housing 214 may have an electrical connection 202, which may be a BUS, a flex connector or other electrical signal connector that allows electrical control of the cartridge by the controller 126 shown in FIG. 1. The housing 214 may have a latch 212 or other physical connector for mechanically engaging to the multirotor aerial vehicle, so the body 214 is not dislodged during flight.

Referring to both FIGS. 1 and 2, the latch 212 may be provided with a beveled tab 213 for slipping across a pressure bump 211 defined along a bottom surface 111 of the deterrence effector bay 110 of FIG. 1. The latch 212 may be flexible enough for slight deflection as it passes over the pressure bump when the housing 214 is pushed into the opening of the deterrence effector bay 110. The pressure bump provides a stop for holding the housing 214 securely to the multirotor aerial vehicle once the latch 212 and pressure bump are engaged. The flexibility of latch 212 may allow for slight deflection of the latch 212 when the body 214 is pulled from the deterrence effector bay in order to release the housing 214 from the deterrence effector bay 110 when finished with the housing 214.

In FIGS. 1 and 2, latch 212 may be of narrow width located near one side of the body 214 with another latch 212 of like form and function provided near another side of the body 214. This may provide a greater holding force of the body 214 to the drone during flight. Only latch 212 of this form and function is depicted in FIGS. 1 and 2. Any latch that functions to hold the body 214 to the drone during flight and is releasable when the body 214 no longer needs to be engaged to the drone may be used with this disclosure.

Referring to FIG. 2, the body 214 may contain electronic circuit 204 configured to electrically communicate with a sensor 210 (shown as sensor 108 in FIG. 1) and a deterrence effector actuator 208 (shown as actuator 162 in FIG. 1). In some embodiments, the controller (shown as processor 126 in FIG. 1) may operate the electronic circuit 204 of cartridge 200 along with operation of other elements of the multirotor aerial vehicle. In some embodiments, the electronic circuit 204 of removable cartridge 200 may have an electrical connection to the processor 126 (shown in FIG. 1) of drone 100, allowing the controller of the UAV-NL to control the cartridge. In some embodiments the removable cartridge 200 may have its own processor separate from the processor 126 operating the UAV-NL shown in FIG. 1. The processor operating the removable cartridge 200 may be included with the electronic circuitry 204. The processor operating the removable cartridge 200 may operate independently of the processor operating the UAV-NL. Alternatively, the processor operating the removable cartridge 200 may be slave to the processor operating the UAV-NL.

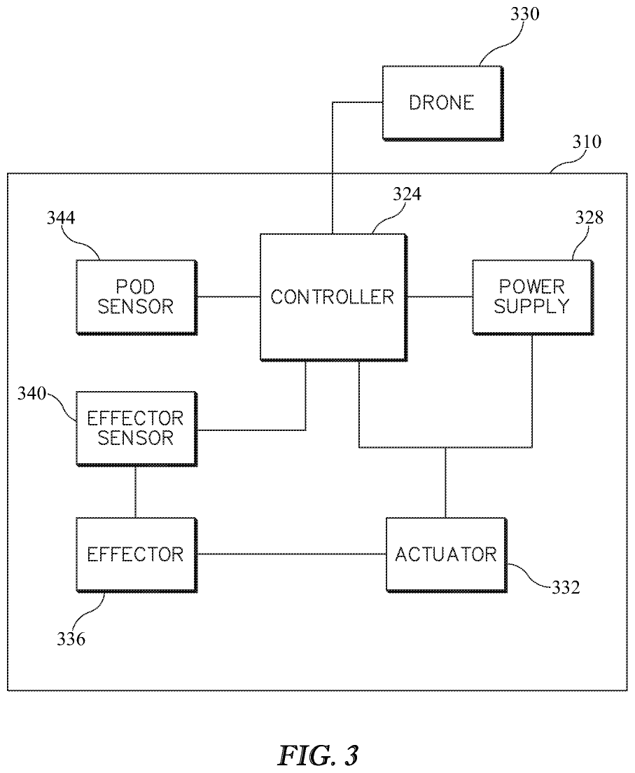

Referring now to FIG. 3, in some embodiments, the removable cartridge 310 may have an independent controller 324 and independent power supply 328. The removable cartridge 200 may have one or more sensors 344 in electrical communication with the controller 324. The sensor(s) 344 may provide targeting or aiming capabilities to the NLDE cartridge. The removable cartridge 310 may have an effector 336, an actuator 332 for causing the effector to be delivered, and a sensor 340 for monitoring the state of the effector (such as level of depletion). In some embodiments the controller 324 may include or have access to a non-volatile memory device which may store a software library.

In some embodiments, the non-lethal deterrence effector 336 may be any one or more of; a sound generator, a light generator, a chemical spray, a liquid discharge, an electrical discharge or a projectile device. In the various embodiments, the general principle for any NLDE is to provide for a non-lethal deterrent to scare, frighten or drive off an intruder. In some aspects, where an intruder is unwilling to flee, it may be useful to use an NLDE that can temporarily incapacitate the intruder. In some aspects, the intruder may be an animal. In some other aspects, the intruder may be a human being. In other aspects, the intruder may be another drone, or some sort of mechanical or automated device. In the various aspects, the use of a non-lethal deterrence effector is meant not to permanently harm an animal or human being in general. Effects of any NLDE on an inanimate object or mechanism is a matter choice.

In an embodiment, the NLDE may be a sound generator. The sound generator may be a speaker powered by electrical energy. The speaker may reproduce recorded sound files stored in a software library, or relay live sound broadcasts received through the wireless communication circuit 128 shown in FIG. 1. Example sounds may be barking dogs, a human voice, a police siren, or a sound effect. In some embodiments the sound generator may be an air horn/fog horn, a bell or other monotonal sound producing device. The sound may be produced by traditional methods (such as compressed gas for horns, or striking a bell), or may be electronically reproduced using the speaker described. Electrical power may be provided by the multirotor aerial vehicle power supply 122, or a dedicated power supply exclusively used for the delivery of the NLDE such as power supply 328 shown in FIG. 3.

In some embodiments the NLDE may be a light generator. The light generator may be a flashing or strobe light, or lights, a visual siren, a scrolling or non-scrolling message board, a spot light, a flood light, a laser pointer or any other form of light emitting device. The light(s) may be produced by light emitting diodes (LED), fluorescent or conventional lights, or chemical reactions (such as flash powder). The lights may be activated using a switch to electrical power, or other mechanism as may be appropriate for the light source.

In some embodiments the NLDE may be a chemical spray. The chemical spray may be tear gas or other aerosolized solid compounds. The chemical spray may be a smelly, noxious gas (rotten egg smell) or other odor.

In some embodiments, the NLDE may be a liquid spray. The liquid spray may be a noxious material to drive off intruders, such as skunk musk. The liquid may be water based or a petroleum product. The NLDE may be any of various agents from skunk musk, to chemical and natural dyes, paint, or noxious odor generating liquids. As with other non-lethal deterrence effectors, the objective may be generally to drive off the intruder without causing permanent harm or lethal injury.

In some embodiments, the NLDE may be an electrical discharge, similar to a taser or stun gun. The voltage may be set to levels to provide a mild electric shock to something more severe.

In some embodiments, the NLDE may be a projectile. Various projectiles may be used. In some embodiments, encapsulated liquid pellets may be used, similar to those used in the sport of paint ball. In some embodiments, rubber “bullets” or other projectiles may be fired using pressurized gases. In some embodiments, the physical projectiles may be solid or semi-solid materials.

The nature of the deterrence effector may be one that can be depleted with usage. If the deterrence effector can be depleted with usage, it may be useful to replenish the supply of the deterrence effector. In some embodiments, the deterrence effector may be contained in a storage tank, such as using compressed gases to drive an air horn, or if the deterrence effector may be a discrete non-lethal munition, such as paint balls, rubber bullets or popping noise makers. A replaceable pod or removable cartridge 200 150 may contain the NLDE and/or any associated components (such as compressed air or rechargeable capacitor) to operate the NLDE. In some embodiments the non-lethal deterrence effector pod 150 may be a magazine, or a canister. In some embodiments the non-lethal deterrence effector may be driven by gases or a high voltage discharge, such as with a capacitor. In some embodiments the non-lethal deterrence effector may be driven by a battery, separate from the battery used to power the multirotor aerial vehicle.

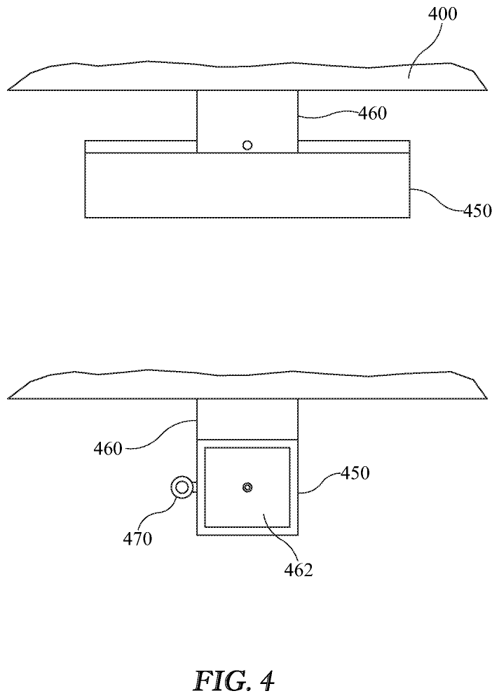

In some embodiments, the deterrence effector bay may be internal to the multirotor aerial vehicle. In some embodiments, the deterrence effector bay may be external to the multirotor aerial vehicle. For example, the deterrence effector bay may be positioned on the external surface of the multirotor aerial vehicle. This can be seen in the side view and front view depictions shown in FIG. 4 of the multirotor aerial vehicle 400. In some embodiments the multirotor aerial vehicle 400 may use a turret 460 like mount to house a deterrence effector bay 450. As explained herein, the deterrence effector bay may receive a cartridge or form a container for holding the non-lethal deterrence effector 336 shown in FIG. 3. The turret 460 may be configured to elevate and/or rotate. Elevation allows the turret 460 to extend the deterrence effector bay 450 away from or bring the deterrence effector bay 450 closer to the multirotor aerial vehicle 400. Rotation allows the deterrence effector bay 450 to rotate with respect to the multirotor aerial vehicle 400. The deterrence effector bay 450, or turret 460 may include a sight camera 470 or other sensor that may be used to aim the NLDE at a target. The sight camera 470 is depicted in the front view of the deterrence effector bay 450 along one side. The sight camera 470 may be positioned along any side of the deterrence effector bay 450, including the top and bottom. While this discussion has illustrated the positioning of the sight camera 470, other sensors may be similarly situated. So too combinations of sight camera and other sensors may be similarly situated on the deterrence effector bay 450. So too may any of the sight camera 470, other sensors, or combinations previously described be situated on the turret also as previously explained. The external deterrence effector bay 450 may receive a removable cartridge 462 as explained in this disclosure. In some embodiments the deterrence effector bay 450 form a container for holding the non-lethal deterrence effector 336 shown in FIG. 3

In some embodiments, the deterrence effector bay may have an actuator 332 shown in FIG. 332. The actuator may be one or more of; a valve, a spray nozzle, a vent, a hammer and a trigger mechanism, a spring, a pneumatic driver, an electric motor, a switch, a magnetic driver or a thermal driver. In some embodiment, the deterrence effector bay may be removable or replaceable. In an aspect, an actuator may be incorporated into the removable or replaceable cartridge design. In some aspects, the actuator may be an integral part of the multirotor aerial vehicle. In some embodiments, the multirotor aerial vehicle may include both integrated and removable versions of NLDE bays.

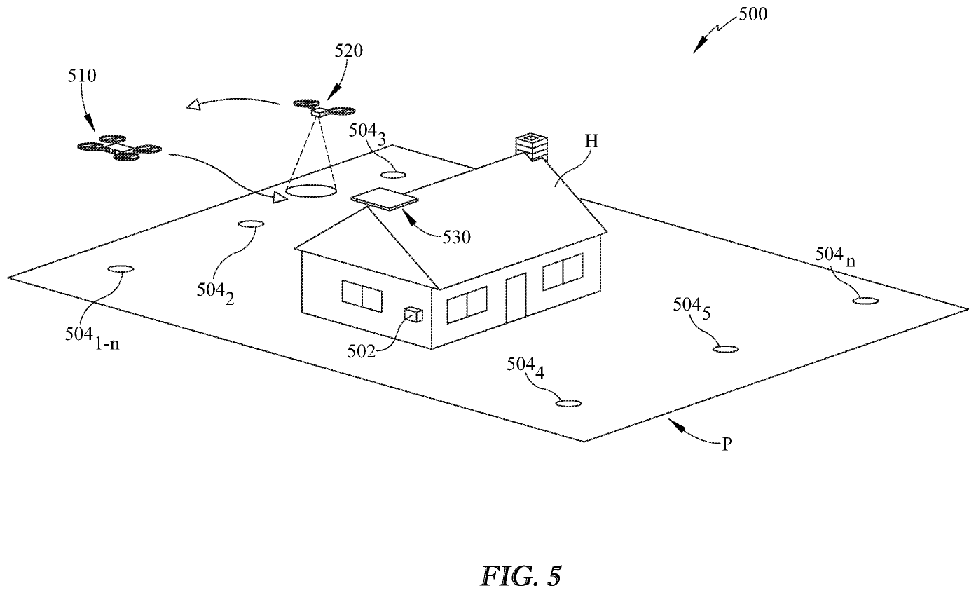

In some embodiments, there may be a security system for detecting and deterring intruders with a non-lethal deterrence effector. FIG. 5 illustrates a security drone operating over a property according to an embodiment. The security system 500 may have a control hub 502, at least one sensor 504₁₋ₙ and a drone with an NLDE 510. The first sensor 504₁₋ₙ may be in signal communication with the control hub 502. When one of the sensors 504₁₋ₙ detects a target entering the first sensor's range, the sensor sends a signal to the control hub, and the control hub may deploy the UAV-NL 510 to investigate the target.

In another embodiment, the control hub 502 may be in communication with a remote wireless computing device. The computing device may instruct the control hub to deploy the UAV-NL 510 to investigate the target. The computing device may be implemented as a portion of a small-form factor portable (or mobile) electronic device such as a cell phone, a smart phone, a personal data assistant (PDA), a personal media player device, a wireless web-watch device, a personal headset device, an application specific device, or a hybrid device that includes any of the above functions. Computing device may also be implemented as a personal computer including both laptop computer and non-laptop computer configurations. In addition, computing device may be implemented as a server as part of a wireless base station or other wireless system or device. In one aspect, the server may provide the drone with cloud computing functionality. A wireless transceiver in the computing device enables the wireless communication between the computing device and the drone

In another aspect, the computing device may receive information from the control hub about the presence of an intruder and the computing device may directly deploy the UAV-NL 510 to investigate the target. In this embodiment, wireless communication circuit 128 (FIG. 1) of the UAV-NL 510 or the scout drone may establish a communication link with the computing device to establish communication between the two and for the drone to receive the instructions.

In some embodiments, the system may utilize a scout UAV 520 without a non-lethal deterrence effector. The control hub 502, directly or indirectly though remote wireless device as previously explained, may deploy the scout UAV 520 to investigate the target identified by the sensor 504, the scout UAV 520 may have a discretion option enumerator software. The discretion option enumerator software may include instructions which when executed compute whether the target identified by the sensor requires the use of a non-lethal deterrence effector. If the determination is made that use of a NLDE is needed, the UAV-NL 510 may be activated.

The premise 500 being protected by the security system may include a house H with a landing station 530 for the UAV-NL. Additional landing stations may be used to increase the range of either the UAV-NL or scout UAV 520. Additional landing stations may also serve as landing platforms for multiple UAV/UAV-NL drones. In some embodiments, a large area may be protected by the distribution of multiple UAV-NL or multiple scout UAV drones.

In some embodiments, the launch pads may be on the roof of the structure, or they may be positioned in a place that may be difficult for a potential intruder to access, such as on a pole, tower or raised platform. The some embodiments, the landing station 530 may be located within or outside the perimeter.

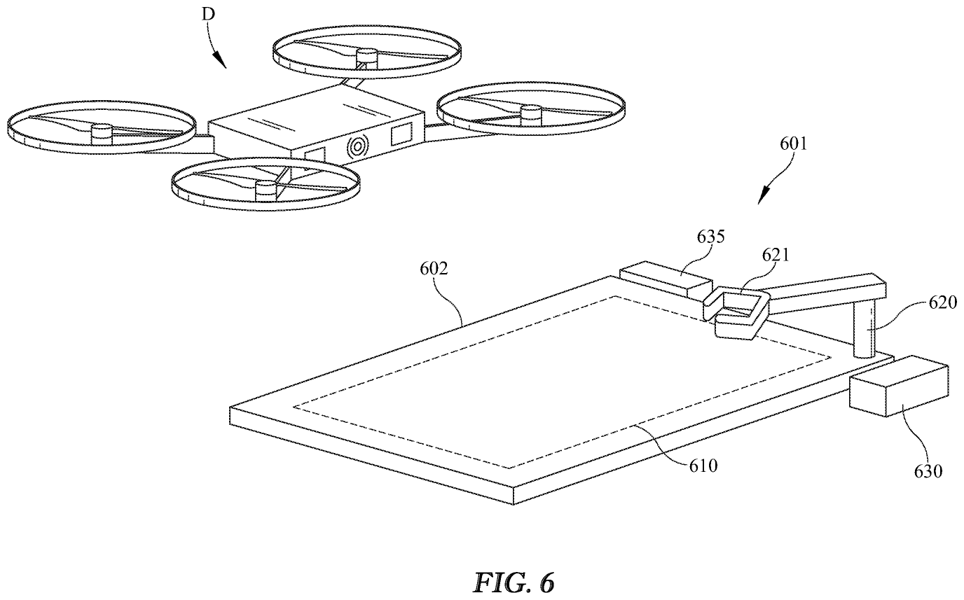

FIG. 6 shows a drone launch pad 601. In some embodiments the drone launch pad 601 may serve as a recharging station for one or more drones. In this manner drones may recharge or refuel between sorties. The drone launch pad 601 may provide a recharging platform 602. The recharging platform 602 may have a wireless recharging base 610 built into the recharging platform 602 so when a drone D comes to rest on the platform, the drone's batteries may automatically recharge. In some embodiments, the drone launch pad 601 may include an electrical connection that allows for wired connection to a power source (not shown), and may.

The platform may include a robotic arm 620 for automatically accessing the deterrent effector cartridges on the drone, and replacing spent or used cartridges from the drone D with fresh cartridges from a supply of new cartridges 630. The robotic arm 620 may be configured to move with six degrees of freedom, moving in x, y, z, pitch, roll, and yaw directions. Spent cartridges may be collected in an optional disposal bin 635. Robotic arm 620 allows for automated replacement of deterrent effector cartridges which may allow for the drones of this disclosure to operate whether or not anyone is at the location of the intrusion. In some embodiments the cartridges may be replaced manually. In some embodiments the cartridges may be replaced automatically.

The recharging platform may have a mechanism for securing the drone to the platform. In an aspect, the robotic arm 620 may be used to secure a drone to the platform. For example, a hand 621 of the robotic arm 620 may be positioned to grab the extension holding the propeller or the propeller and to hold the extension or propeller securely so that the drone may not be taken. In another aspect, the platform may have a magnetic coupling to help hold the drone to the platform. In some other embodiments, the platform may function like a hanger for one or more drones, and protect the drones from adverse weather conditions, debris and/or other environmental hazards. The hanger may have a side that may be opened to allow the one or more drones to depart and that may be closed and kept under lock and key when the drones are not in operation.

In some embodiments, the control hub acts as a security agent acting on behalf of an external security service provider, wherein the security agent may be autonomous in coordinating sensor data from the sensors and the deployment of the UAV to investigate the target. Either the control hub or the UAV-NL may utilize a delivery option enumerator software including instructions which when executed compute a set of delivery options in accordance with a set of constraint parameters to select one or more of available non-lethal deterrence effectors to deliver to the target.

The security agent may be the local equipment and/or programs from a security service provider. Typically the agent may be calibrated to work with a group of sensors and monitor the sensor for intrusion or emergencies (such as fire, carbon monoxide, loss of power, etc. . . . ).

The delivery option enumerator software may be a set of instructions the UAV-NL or the control hub uses to determine whether a non-lethal deterrence effector should be used, and if a NLDE should be used, which one of the available NLDE's should be delivered to the target. The instruction set may be a chain of decision points arranged in a logic that starts with the UAV-NL doing nothing, and scaling up to the UAV-NL delivering a large load of area effect tear gas, and an escalation to call in emergency services for assistance. Many possible responses lie between these two extremes, and the delivery option enumerator software may go through the possible options to derive an appropriate response. The response may be modified by a user override, or a verification authorization if the NLDE response is set as being too extreme without external authorization. The delivery options may refer to the selection of the NLDE to use, and how much or how intense the delivery should be.

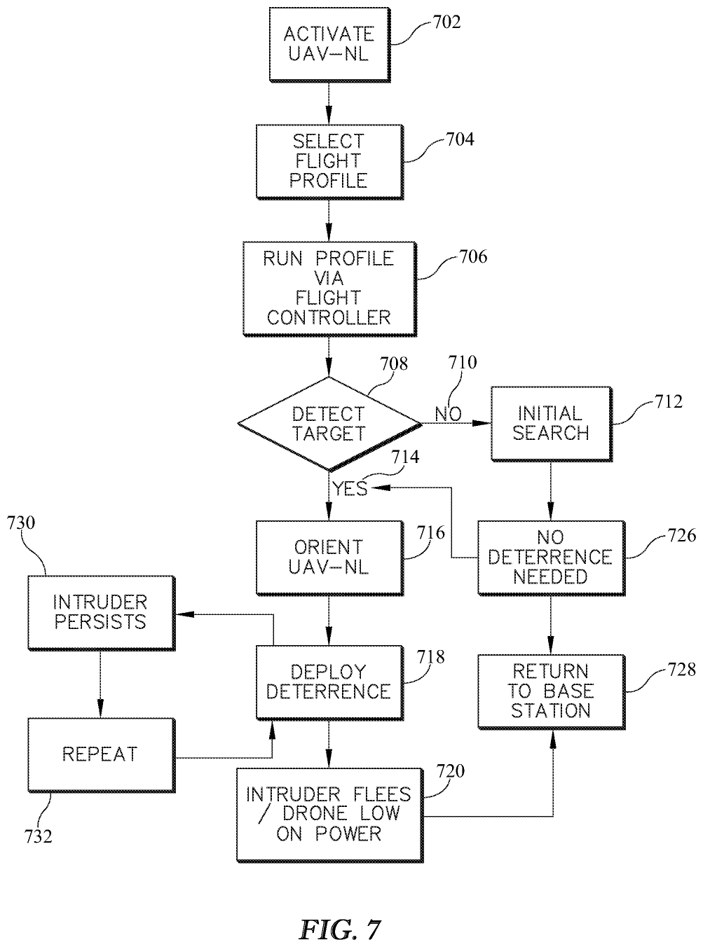

In some embodiments, there is a method of controlling a UAV-NL for delivery of a deterrence effector at a target. As shown in FIG. 7, the method may activate 702 the UAV-NL via a wireless communication protocol. Once the UAV-NL is activated, a preprogrammed flight profile may be selected from a software library 704. The program may then be run 706 using the controller on board the UAV-NL. The UAV-NL may detect a target 708, and direct the controller to correct the UAV-NL orientation 716 so as to align a direction of discharge of the non-lethal deterrence effector at the target. The UAV-NL may then deliver 718 the non-lethal deterrence effector at the target. The UAV-NL may then select from a number of tasks, including returning to base 728 to recharge.

In some embodiments, the method of using the UAV-NL may involve receiving a target position alert from a security system, deploying an observation drone to the position of an intruder, verifying the intruder, and sending a signal for the activation of a drone for delivery of a non-lethal deterrence effector at the target.

In some embodiments, the UAV-NL or the scout UAV may proceed to the area where the security alert was triggered, and conduct a search 712 to locate the cause of the alarm. This may involve the drones flying in a pattern around the sensor. If the drone does not find the cause of the alarm, or if the drone determines that no deterrence is needed 726, the drone may return to base 728 to recharge. In some embodiments, if the intruder is found and a deterrence effector is used, the UAV-NL may follow 720 the intruder to ensure the intruder leaves the premises. In some embodiments, the intruder may persist 730 even after a first deterrence effector is used. In this case the UAV-NL may select another non-lethal deterrence effector and repeat the deterrence process 732.

In some embodiments, the drone may have a microphone as one of its sensors. The microphone may be used to attempt two way communication with the intruder and the security system, either through the monitoring service, property owner, or any other party using the UAV-NL as a mobile speaker phone.

### Example I

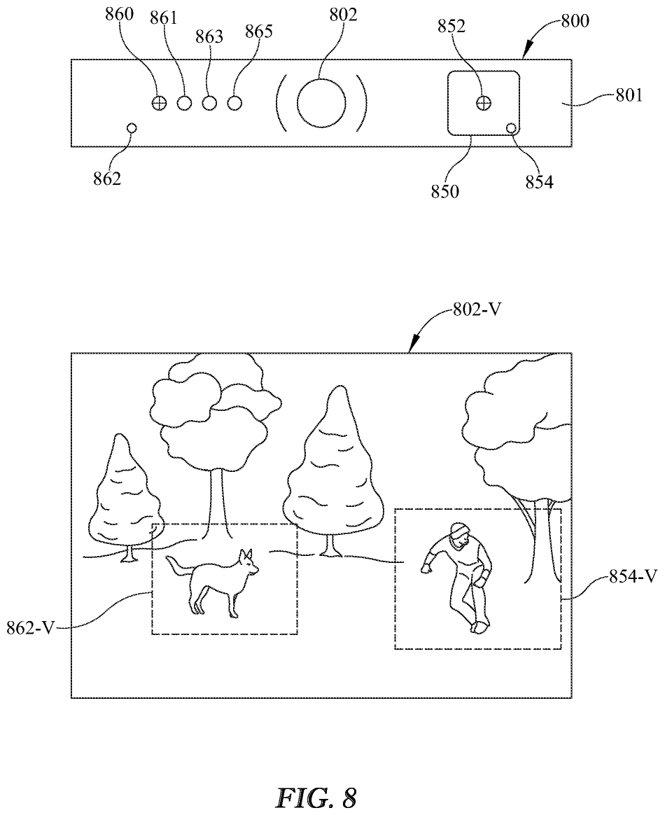

FIG. 8 depicts an illustrative UAV-NL 800 with a front face 801 including a first sensor 802 that may be used for navigation. The UAV-NL 800 may include an NLDE deterrence effector bay 850 that is integrated or that receives a cartridge as described in this disclosure. The UAV-NL 800 may be provided with a sensor 862 and the NLDE deterrence effector bay 850 may be provided with a sensor 854. Either or both sensors 862, 854 may be configured for aiming an NLDE actuator 860. In an illustrative embodiment, sensor 862 may be a camera and sensor 854 a proximity sensor. The actuator may be any device described herein, or any other suitable device for the same purpose.

The UAV-NL 800 may be provided with a light source 861 for providing illumination at night. The UAV-NL 800 may be provided with a sensor 863 configured for infra-red vision, a GPS sensor, a proximity sensor, an echo location sensor, an RF sensor, and a waypoint sensor The UAV-NL 800 may be provided with other deterrence effectors 863 that may be separate from the deterrence effector held by the NLDE deterrence effector bay 850. For example, the other deterrence effectors 863 may be a sound generator, a light generator. In some embodiments, the NLDE deterrence effector bay 850 may contain a chemical spray, a liquid discharge, an electrical discharge or a projectile device while the other deterrence effectors 863 may provide a sound generator, a light generator, and so on. In some embodiments, the other deterrence effectors 863 may be contained by another NLDE deterrence effector bay that may be separate from the NLDE deterrence effector bay 850. In some embodiments, the another NLDE deterrence effector bay may be integrated or receive a cartridge as explained throughout this disclosure.

In another embodiment, the UAV-NL 800 may be provided with still other deterrence effectors 865. In one aspect, UAV-NL 800 may include a camera as sensor 860, a light source 863, deterrence effector 863 may be an infra-red sensor, and deterrence effector 865 may be a microphone and/or speaker.

While the front face 801 of UAV-NL 800 is depicted with illustrative sensors, illustrative NLDE deterrence effectors, and illustrative NLDE deterrence effector bays, there may be embodiments where any combination of one or more of these features may be used with the drone of this disclosure. As taught by this disclosure, any number of sensors, NLDE deterrence effectors, and NLDE deterrence effector bays may be used with the drone of this disclosure.

As shown in the lower drawing in FIG. 8, during flight operations, the UAV-NL 800 depicted in the upper drawing in FIG. 8 may see one or more targets in an area of vision 802-V. In this example, in the area of vision 802-V, the UAV-NL 800 sees a dog and a human. The UAV-NL 800 sees the dog in a sector 854-V of the area of vision 802-V and the human in a sector 862-V of the area of vision 802-V. The UAV-NL 800 may select one of the targets first to identify the target as something it should respond to, such as the human in sector 854-V. The UAV-NL 800 may use the methods described herein to determine next steps. For example, with reference to FIG. 7, the UAV-NL 800 may execute step 708 to detect that the target is a human who is an intruder. At step 716, the UAV-NL 800 may orient the UAV-NL 800 so that on actuation of the NLDE deterrence effector bay 850 the deterrence effector is aimed at the intruder. At step 718, the UAV-NL 800 may deploy the deterrence effector 718, and at step 730 repeat the deployment if the intruder persists. The UAV-NL 800 may select the other one of the targets to identify the target as something it should respond to, such as the dog in sector 862-V and use the methods of this disclosure to determine next steps.

### Example II

In some embodiments, the UAV-NL 800 may respond differently to different targets. In an aspect, the UAV-NL 800 may identify an intruder as a wild animal. The UAV-NL may decide the animal poses no threat to the secured property or anyone contained within the property. The UAV-NL 800 may elect to do nothing. In another aspect, the wild animal may represent a predator to livestock or small children within the secured property. An enumerator software may include a library of protocols for use with different intruders and the enumerator software may sort through the library of protocols to determine the proper protocol to use with the identified intruder. The UAV-NL 800 may then call up the software of the selected protocol and execute the instructions of the selected protocol software to deal with the instant intruder. If the animal detected is a large carnivore, the UAV-NL 800 may seek to use its strongest and most effective deterrence effector on the first attempt in order to chase the animal away.

In other aspect, the intruder may be identified as a small child, or an individual who needs help. The UAV-NL 800 may select from a library of protocols for use with different intruders in enumerator software the proper protocol to use with the identified intruder. Once selected, the UAV-NL 800 may execute the software associated with selected protocol that, in this example, establishes two way communication between the intruder and the control hub/facility agent using the UAV-NL as a communication tool.

In another aspect, the intruder may be identified as a person with malicious intent. The UAV-NL 800 may then choose from a library of protocols for use with different intruders in enumerator software the proper protocol to use with the identified intruder. The proper protocol, or protocols if more than one protocol may be applicable, may include a variety of options from verbal warning, to use of a powerful deterrence effector, such as tear gas. The verbal warning may occur through a microphone in the deterrence effector 865. In another embodiment, the deterrence effector 865 may be provided with a speaker configured for audio pick-up from an intruder. In one aspect, a microphone and speaker adapted to the UAV-NL 800 may allow for communication with an intruder. For example, the UAV-NL 800 may speak through the speaker to a human intruder and the response of the intruder may be picked up through the microphone. As another example, the UAV-NL 800 may speak through the speaker to an intruder and the response of the intruder may be picked up through the microphone. In another example, the deterrence effector 865 may be a speaker or a microphone for one-way communication with an intruder.

The UAV-NL 800 may select from any NLDE it has access to in flight, or may call for a “back up” UAV-NL that may be carrying a different assortment of NLDEs, which may be better suited to dealing with the intruder.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer program instructions, encoded on one or more computer storage medium for execution by, or to control the operation of, data processing apparatus, such as a processing circuit. A controller or processing circuit such as CPU may comprise any digital and/or analog circuit components configured to perform the functions described herein, such as a microprocessor, microcontroller, application-specific integrated circuit, programmable logic, etc. Alternatively or in addition, the program instructions may be encoded on an artificially generated propagated signal, e.g., a machine-generated electrical, optical, or electromagnetic signal that is generated to encode information for transmission to suitable receiver apparatus for execution by a data processing apparatus.

A computer storage medium, also referred to herein as memory or memory device, may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate components or media (e.g., multiple CDs, disks, or other storage devices). Accordingly, the computer storage medium is both tangible and non-transitory.

The operations described in this specification may be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application specific integrated circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

There is thus described a drone for deterring intruders within a monitored area. The apparatus provides a multirotor aerial vehicle with an electric drive apparatus and a power supply configured to provide electrical energy, a controller configured to control the multirotor aerial vehicle, a first sensor in electrical communication with the controller, the sensor configured to provide navigation information to the controller, a wireless communication circuit in electrical communication with the controller, and in wireless communication with an external wireless transceiver and a deterrence effector bay in electrical communication with the controller, the deterrence effector bay comprising a non-lethal deterrence effector and an actuator, wherein activation of the actuator causes the delivery of the non-lethal deterrence effector to a target.

The multirotor aerial vehicle controller may further comprise a deterrence effector controller configured for control of deterrence effector delivery: to detect the target, and upon detecting the target, to direct the flight of the multirotor aerial vehicle to align the direction of delivery of the deterrence effector to the direction of the target, and to actuate the actuator to deliver the deterrence effector at the target.

The multirotor aerial vehicle controller may be a processor. The processor further comprises an integrated or adjunct non-volatile memory device, the memory device storing a software library, the software library comprising one or more of a deterrence effector controller software, a sensor controller software, a controller software and a software for control of deterrence effector delivery.

The multirotor aerial vehicle sensors may be one of: an optical camera, a GPS sensor, a proximity sensor, an echo location sensor, an RF sensor, and/or a waypoint sensor.

The multirotor aerial vehicle wherein control of the operation of the first sensor is provided by the sensor controller software, the sensor controller software comprising correction logic and navigation logic. The navigation logic may override the instructions of the controller in piloting the multirotor aerial vehicle.

The multirotor aerial vehicle may have one or more sensors, and one or more of the sensors may be a targeting sensor.

The multirotor aerial vehicle controller may navigate the multirotor aerial vehicle using a combination of sensor data from the one or more sensors.

The multirotor aerial vehicle deterrence effector bay may be removable or replaceable. The deterrence effector bay may be internal or external to the multirotor aerial vehicle.

The multirotor aerial vehicle deterrence effector bay actuator may be one or more of; a valve, a spray nozzle, a vent, a hammer and a trigger mechanism, a spring, a pneumatic driver, an electric motor, and a magnetic or thermal driver. The deterrence effector bay may have a sensor in signal communication with the controller.

The non-lethal deterrence effector may be any one or more of; a sound generator, a light generator, a chemical spray, a liquid discharge, an electrical discharge or a projectile device.

There is also described a security system for detecting and deterring intruders with a non-lethal deterrence effector. The security system comprising, a control hub, a first sensor in signal communication with the control hub, a first unmanned aerial vehicle (UAV-NL) in signal communication with the control hub, the UAV-NL equipped with a non-lethal deterrence effector, wherein the first sensor detects a target entering the first sensor's range, and signals the control hub to deploy the UAV to investigate the target.

The security system control hub comprises a security agent acting on behalf of an external security service provider, wherein the security agent is autonomous in coordinating sensor data from the first sensor and the deployment of the UAV to investigate the target, the control hub or the UAV utilizing a delivery option enumerator software for computing a set of delivery options in accordance with a set of constraint parameters to select one or more of available non-lethal deterrence effectors to deliver to the target.

The system may use a second scout UAV without a non-lethal deterrence effector. The control hub deploys the scout UAV to investigate the target identified by the sensor, the scout UAV has a discretion option enumerator software for computing whether the target identified by the sensor requires the use of a non-lethal deterrence effector.

There is also a method of controlling a UAV-NL for delivery of a deterrence effector at a target. The method provides for; activating the UAV-NL via a wireless communication protocol, selecting a preprogrammed flight profile from a software library, running the preprogrammed flight profile through a controller on board the UAV-NL, detecting a target, directing a controller to correct the UAV-NL orientation so as to align a direction of discharge of the non-lethal deterrence effector at the target, delivering the non-lethal deterrence effector at the target and returning the UAV-NL to a recharging base.

In the method, activation of a UAV-NL may also provide for; receiving a target position alert from a security system; deploying a scout drone to the position of the an intruder, verifying the intruder and signaling for the activation of a drone for delivery of a non-lethal deterrence effector at the target.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. In some cases, the actions recited herein may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A drone for deterring intruders within a monitored area, the apparatus comprising:
a multirotor aerial vehicle comprising a plurality of lift-producing rotors, an electric drive apparatus configured for driving the rotors, and a power supply configured to provide electrical energy;
a controller configured to control the multirotor aerial vehicle;
a first sensor in electrical communication with the controller, the sensor configured to provide navigation information to the controller;
a wireless communication circuit in electrical communication with the controller, and in wireless communication with an external wireless transceiver;
a deterrence effector bay in electrical communication with the controller, the deterrence effector bay comprising a non-lethal deterrence effector and an actuator, wherein activation of the actuator causes the delivery of the non-lethal deterrence effector to a target.

2. The multirotor aerial vehicle of claim 1, wherein the controller is further configured to control deterrence effector delivery: to detect the target, and upon detecting the target, to direct the flight of the multirotor aerial vehicle to align the direction of delivery of the deterrence effector to the direction of the target, and to actuate the actuator to deliver the deterrence effector at the target.

3. The multirotor aerial vehicle of claim 1, wherein the controller is a processor.

4. The multirotor aerial vehicle of claim 3, wherein the processor further comprises an integrated or adjunct non-volatile memory device, the memory device storing a software library, the software library comprising one or more of a deterrence effector controller software, a sensor controller software, a flight controller software and a software for control of deterrence effector delivery.

5. The multirotor aerial vehicle of claim 1, wherein the first sensor is one of: an optical camera, a GPS sensor, a proximity sensor, an echo location sensor, an RF sensor, and a waypoint sensor.

6. The multirotor aerial vehicle of claim 4, wherein control of the operation of the first sensor is provided by the sensor controller software, the sensor controller software comprising correction logic and navigation logic.

7. The multirotor aerial vehicle of claim 6, wherein the navigation logic overrides the instructions of the flight controller in piloting the drone.

8. The multirotor aerial vehicle of claim 1, wherein the first sensor is a targeting sensor.

9. The multirotor aerial vehicle of claim 1, wherein the multirotor aerial vehicle comprises a plurality of sensors.

10. The multirotor aerial vehicle of claim 9, wherein the controller navigates the multirotor aerial vehicle using a combination of sensor data from the plurality of sensors.

11. The multirotor aerial vehicle of claim 9, wherein the plurality of sensors are any one of: an optical camera, a GPS sensor, a proximity sensor, an echo location sensor, an RF sensor, and a waypoint sensor.

12. The multirotor aerial vehicle of claim 9, wherein any one or more of the plurality of sensors is a targeting sensor.

13. The multirotor aerial vehicle of claim 1, wherein the deterrence effector bay is removable.

14. The multirotor aerial vehicle of claim 1, wherein the deterrence effector bay is replaceable.

15. The multirotor aerial vehicle of claim 1, wherein the deterrence effector bay is internal.

16. The multirotor aerial vehicle of claim 1, wherein the deterrence effector bay is external.

17. The multirotor aerial vehicle of claim 1, wherein the actuator comprises one of; a valve, a spray nozzle, a vent, a hammer and a trigger mechanism, a spring, a pneumatic driver, an electric motor, and a magnetic or thermal driver.

18. The multirotor aerial vehicle of claim 1, wherein the deterrence effector bay further comprises a second sensor in signal communication with the controller.

19. The multirotor aerial vehicle of claim 1, wherein the non-lethal deterrence effector comprises at least one of a sound generator, a light generator, a chemical spray, a liquid discharge, an electrical discharge and a projectile device.

20. A security system for detecting and deterring intruders with a non-lethal deterrence effector, the security system comprising:
a control hub;
a first sensor in signal communication with the control hub;
a first drone in signal communication with the control hub, the first drone comprising one or more non-lethal deterrence effectors;
wherein the first sensor detects a target entering the first sensor's range, and signals the control hub to deploy the first drone to investigate the target.

21. The security system as described in claim 20, wherein the control hub comprises a security agent acting on behalf of an external security service provider, wherein the security agent is autonomous in coordinating sensor data from the first sensor and the deployment of the first drone to investigate the target, the control hub or the first drone comprising:
a delivery option enumerator software for computing a set of delivery options in accordance with a set of constraint parameters to select one or more of the one or more non-lethal deterrence effectors to deliver to the target.

22. The system of claim 20, further comprising a scout drone without a non-lethal deterrence effector, wherein the control hub deploys the scout drone to investigate the target identified by the sensor, the scout drone including a discretion option enumerator software for computing whether the target identified by the sensor requires the use of a non-lethal deterrence effector.

23. A method of controlling a UAV for delivery of a deterrence effector at a target, the method comprising:
activating the UAV via a wireless communication protocol;
selecting a preprogrammed flight profile from a software library;
running the preprogrammed flight profile through a controller on board the UAV;
detecting a target;
directing a controller to correct the UAV orientation so as to align a direction of discharge of the non-lethal deterrence effector at the target;
delivering the non-lethal deterrence effector at the target; and
returning the UAV to a recharging base.

24. The method of claim 23, wherein the activation of a UAV further comprises:
receiving a target position alert from a security system;
deploying an observation drone to the position of an intruder;
verifying the intruder; and
signaling for the activation of a drone for delivery of a non-lethal deterrence effector at the target.
